(19) United States
(12) Patent Application Publication
(10) Pub. No.: US 2015/0019242 A1
(43) Pub. Date: Jan. 15, 2015

(54) MEDICAMENT MANAGEMENT APPARATUS AND METHOD FOR MANAGING MEDICAMENT BY THE SAME

(71) Applicant: TOSHIBA TEC KABUSHIKI KAISHA, Tokyo (JP)

(72) Inventors: Toshihide Murata, Izunokuni-shi (JP); Shiomi Matsui, Izunokuni-shi (JP); Hirokazu Watanabe, Tokyo-to (JP); Shunichiro Kamamoto, Izunokuni-shi (JP)

(21) Appl. No.: 14/326,666

(22) Filed: Jul. 9, 2014

(30) Foreign Application Priority Data
Jul. 10, 2013 (JP) 2013-144690

(51) Int. Cl. G06F 19/00

(52) U.S. Cl. CPC G06F 19/326
USPC 705/2

(57) ABSTRACT

The medicament information storage section stores a plurality of types of drug codes respectively assigned to each medicament. The slip information storage section stores, for each use of a slip for notifying information of the medicament used at a medical site, information of the type of drug codes required for the use of the slip. The specifying module specifies the medicament used at the medical site. The registration module registers information relating to the medicament specified by the specifying module. The creation module acquires the drug code of the medicament registered by the registration module for each slip having different use from the medicament information storage section to create slips for different uses based on the information stored in the slip information storage section. The output module outputs the slips created by the creation module for different uses.

### CROSS-REFERENCE TO RELATED APPLICATION

This application is based upon and claims the benefit of priority from Japanese Patent Application No. 2013-144690, filed Jul. 10, 2013, the entire contents of which are incorporated herein by reference.

### FIELD

Embodiments described herein relate to a medicament management apparatus for managing a consumed medicament at a medical site and a medicament management method by the medicament management apparatus.

### BACKGROUND

At a medical site such as a hospital, a cost for the medicament used or consumed in a surgery or a medical examination is generally charged to both the patient and the health insurance society the patient joins. Thus, it is necessary to correctly grasp the name, the quantity and the like of the medicament or drug consumed in an event such as a surgery at the medical site.

For example, in an operating room, a lot of medicaments are properly stored in a storage locker or shelf, and the quantity thereof is managed for each medicament. Thus, if the medicament in the storage locker is used in a surgery, it is necessary to replenish the same quantity of the medicament consumed in the surgery from an external medicament storage room. A structure or arrangement for managing the quantity of medicament taken out from the medicament storage room for the replenishment has been proposed.

However, the work of counting the quantity of the medicament used in a surgery, for example, relies on manpower such as a nurse. Thus, the workload of an operator is huge. Further, in a case in which confusion or happening is caused at the medical site due to, for example, the sudden change of the patient's condition during a surgery, it can be easily imagined that a counting error of the quantity of the consumed medicament or a transcription error of the counted value or quantity and the like may occur, which may lead to a problem that the charge for a cost for the consumed medicament or the replenishment of the consumed medicament to the storage locker in the operating room is left out by mistake.

### BRIEF DESCRIPTION OF THE DRAWINGS

FIG. 1 is an external oblique view illustrating the whole constitution of a medicament management apparatus according to one embodiment;

FIG. 2 is a block diagram illustrating the constitution of the main portions of a main body in the medicament management apparatus;

FIG. 3 is a schematic view illustrating the data structure of a medicament record stored in a medicament database;

FIG. 4 is a schematic view illustrating the data structure of a slip record stored in a slip database;

FIG. 5 is a schematic view illustrating the data structure of a surgery record stored in a surgery database;

FIG. 6 is a schematic view illustrating the area constitution of a medicament registration table;

FIG. 7 is a flowchart illustrating the procedure of information processing executed by a CPU according to a medicament management program;

FIG. 8 is a flowchart specifically illustrating the procedure of slip issuing processing in FIG. 7;

FIG. 9 is a diagram illustrating a specific example of a slip record of a used medicament slip for accounting and a slip record of a used medicament slip for replenishment;

FIG. 10 is a diagram illustrating an output example of the used medicament slip for accounting; and

FIG. 11 is a diagram illustrating an output example of the used medicament slip for replenishment.

### DETAILED DESCRIPTION

In accordance with one embodiment, a medicament management apparatus comprises a medicament data storage section, a slip information storage section, a specifying module, a registration module, a creation module and an output module. The medicament information storage section stores a plurality of types of drug codes which are respectively assigned to each medicament.

The slip information storage section stores, for each different use of a slip for notifying information of the medicament used at a medical site, information of the type of drug codes required for the use of the slip.

The specifying module specifies the medicament used at the medical site. The registration module registers information relating to the medicament specified by the specifying module. The creation module acquires the drug code of the medicament registered by the registration module for each slip having different use from the medicament information storage section to create slips for uses different from one another based on the information stored in the slip information storage section. The output module outputs the slips for uses different from one another created by the creation module.

An embodiment of the medicament management apparatus is described below with reference to the accompanying drawings. In the embodiment, the medicament management apparatus is arranged in an operating room, which is an example of the medical site. An exemplified medicament management apparatus 1 registers information of the medicament used in the operating room and outputs a first slip required to charge the cost for the used medicament and a second slip required to replenish a medicament storage locker with the medicament of the consumed amount.

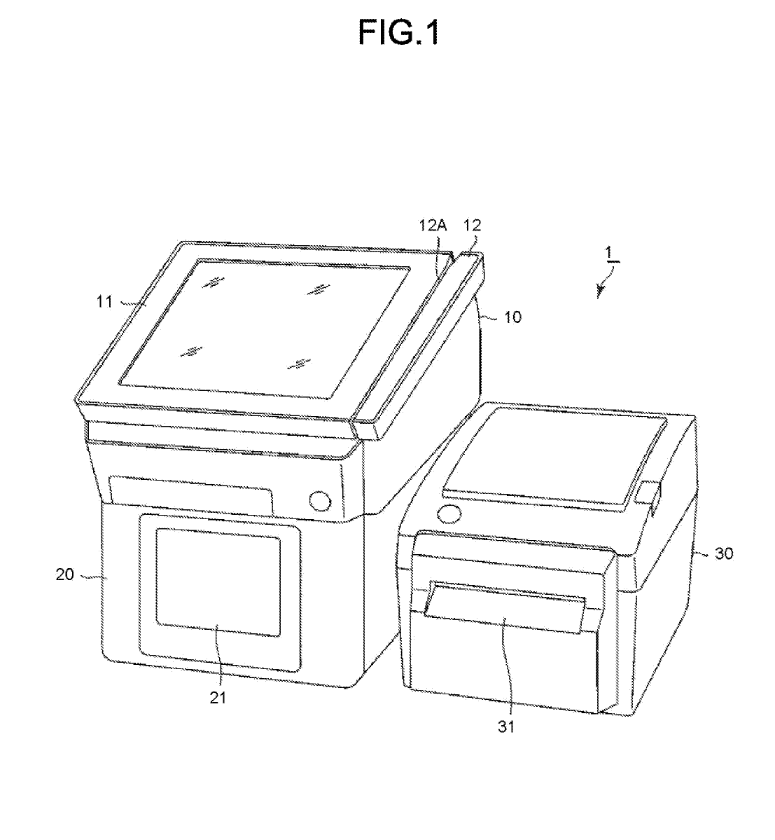

FIG. 1 is an external oblique view illustrating the whole constitution of the medicament management apparatus 1. The medicament management apparatus 1 comprises a management apparatus main body (hereinafter referred to as a main body) 10, a scanner 20 and a slip printer 30. The main body 10 is arranged on the scanner 20 and is electrically connected with the scanner 20 through an interface. The slip printer 30 is electrically connected with the main body 10 through the interface.

The main body 10 is equipped with a touch panel 11 functioning as an operation-display section; at the upper portion thereof. The main body 10 is also equipped with a card reader 12 at one side of the touch panel 11. The card reader 12 reads the data of a magnetic card sliding along a slide groove 12A. The magnetic card may be a patient card issued for a patient or an ID (Identification) card issued for medical personnel such as a doctor and a nurse. A patient code for specifying the patient is recorded in the patient card. A code or electronic symbol used to identify the doctor or the nurse is recorded in the ID card.

The card reader 12 is not limited to a reader for reading a magnetic card. If the card is an IC (Integrated Circuit) card or an RFID (Radio Frequency Identification) card, any card reader that can read the data of each card can be adopted. Further, the card is not limited to the patient card and the ID card.

The scanner 20 scans a target object with electromagnetic wave (light or electric wave and the like) converged in a linear state or in a dotted state to read information from the target object. The scanner 20 is provided with a reading window 21 in the front surface thereof. The reading window 21 can transmit and emit electromagnetic wave towards the outside of the window. In a case of reading the data code attached to an object such as a commodity, the object is held over the reading window 21 to scan a data code symbol. In the present embodiment, a container in which a given standard unit of medicament is stored is held to the reading window 21 by a field staff such as a nurse. A graphic symbol obtained by symbolizing the data code such as a barcode, two-dimensional data code, GS1 (Global Standard One) code is recorded on the container. The data code read by the scanner 20 contains at least the data capable of identifying individual medicament.

The slip printer 30 prints slip data on a slip paper having a specified form and discharges the printed slip paper through a slip issuing port 31 to issue a slip. The slip printer 30 is used to print a used medicament slip on which the detail of the medicament consumed in a surgery is recorded, for example. The used medicament slip includes a first slip for accounting which is to be submitted to a medical accounting department to charge a cost for the used medicament and a second slip for replenishment which is to be submitted to a medicament management department to request the replenishment of the used medicament.

Slips that can be output by the medicament management apparatus 1 are not limited to the used medicament slip described above. The slips include a borrowed medicament slip on which the detail of the medicament borrowed from a place different from the medicament storage room, for example, a storage locker of an operating room next to the operating room where the surgery is performed, for example, is recorded, and a scrapped medicament slip on which the detail of the medicament dropped on the floor and therefore scrapped without being used, for example, is recorded. These slips are output not only as a personal slip for each patient but also as an aggregate slip on which aggregated quantities of the medicament in one day is printed.

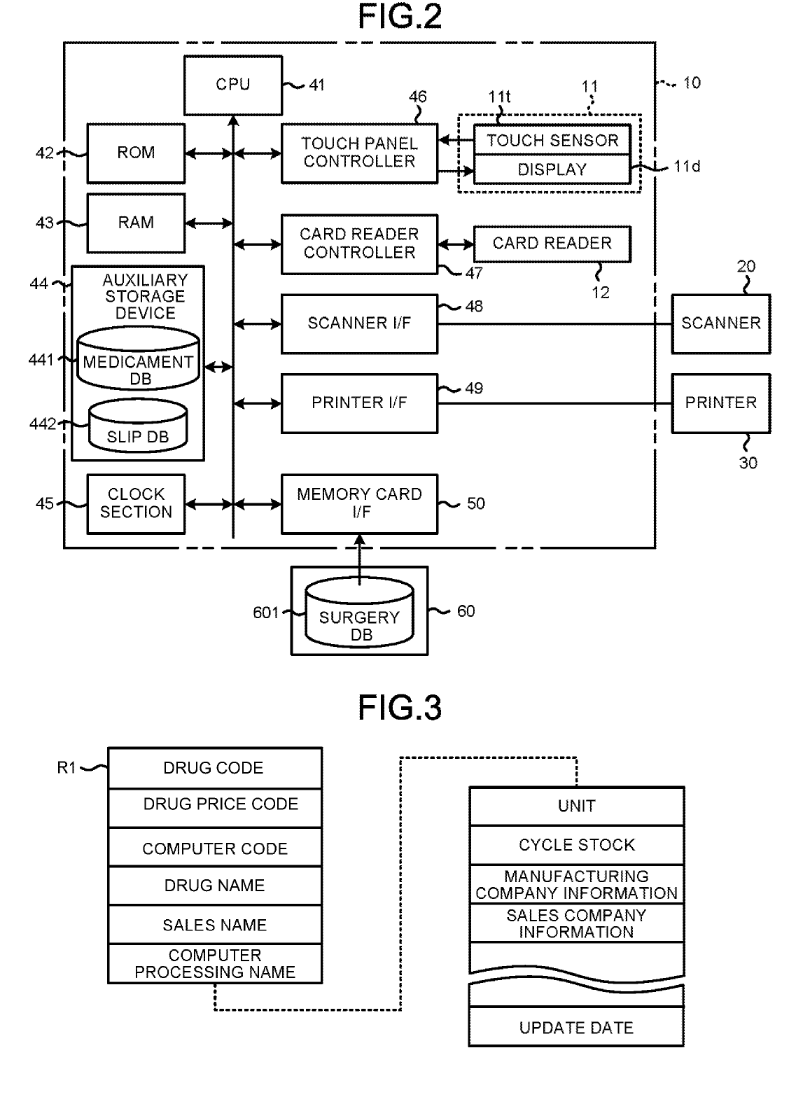

FIG. 2 is a block diagram illustrating the constitution of the main portions of the main body 10. The main body 10 comprises a CPU (Central Processing Unit) 41, a ROM (Read Only Memory) 42, a RAM (Random Access Memory) 43, an auxiliary storage device 44, a clock section 45, a touch panel controller 46, a card reader controller 47, a scanner interface 48, a printer interface 49, a memory card interface 50 and a system bus line 51. The system bus line 51 connects the CPU 41, ROM 42, RAM 43, auxiliary storage device 44, clock section 45, touch panel controller 46, card reader controller 47, scanner interface 48, printer interface 49 and memory card interface 50 with each other.

The CPU 41 is a central part of a computer. The CPU 41 controls each section to realize various functions of the medicament management apparatus 1 according to an operating system or application programs.

The ROM 42 is a main storage part of the computer. The ROM 42 stores the operating system and the application program mentioned above. As occasion demands, the ROM 42 also stores data required to execute various processing by the CPU 41.

The RAM 43 is also a main storage part of the computer mentioned above. The RAM 43 stores data required to execute various processing by the CPU 41 as needed. Further, the RAM 43 is also used as a work area for the CPU 41 when various processing is executed.

The auxiliary storage device 44 corresponds to a storage part of the computer. The auxiliary storage device 44 is, for example, an EEPROM (electric erasable programmable read-only memory), a HDD (hard disk drive), a SSD (solid state drive) and the like. The auxiliary storage device 44 stores data used by the CPU 41 to carry out various processing and data generated in the processing carried out by the CPU 41. As occasion demands, the auxiliary storage device 44 also stores the application programs.

At least a medicament database 441 and a slip database 442 are stored in the auxiliary storage device 44. The medicament database 441 stores a medicament record R1 generated for each medicament. As shown in FIG. 3, the medicament record R1 contains data items such as a medicament or drug code, medicament or drug price code, computing code, medicament or drug name, sales name, computer processing name, unit, cycle stock, manufacturing company information, sales company information, updating date and the like. The medicament database 441 is properly updated by a computer system different from the medicament management apparatus and the latest version thereof is downloaded to the auxiliary storage device 44 through the memory card 60.

The drug code, which is a unique code for specifying the category of medicament, contains a number representing the medicament and a universal commodity code for identifying the medicament individually. The data code including the drug code such as the two-dimensional data code, the GS1 (Global Standard One) code, the barcode and the like is symbolized and attached to the container of each medicament.

The drug price code, which is assigned to drugs listed in the National Health Insurance Drug Price Standard designated by a public institution, represents the ingredients, dosage form, brand and the like of the medicament. The official name or title is the National Hearth Insurance Drug Price Listing Drug Code.

The computing code, which is used when a medical institution charges an insurance institution a medical fee, contains a medicinal effect classification number and an individual number. The official name or title is the Receipt Computer Processing System Basic Master Drug Code.

The drug name is the official name of the medicament. The sales name is a common name used when the medicament is sold as medicinal supplies. The computer processing name is used when the medical institution charges an insurance institution a medical fee. As to each name, at least two types or all the types are common for one kind of medicament. Further, each name may also be different from each other.

The unit is a standard unit representing the active ingredient quantity of the medicament stored in the container. The cycle stock is the quantity of medicament which is always kept in the storage locker of the medical site (operating room) where the medicament management apparatus 1 is arranged. The manufacturing company information and the sales company information is information relating to the manufacturing company and the sales company of the medicament. The updating date is the latest date on which the record is updated.

The medicament database 441 functions as a medicament information storage section for storing a plurality of types of drug codes respectively assigned to each medicament and a plurality of types of names respectively assigned to each medicament.

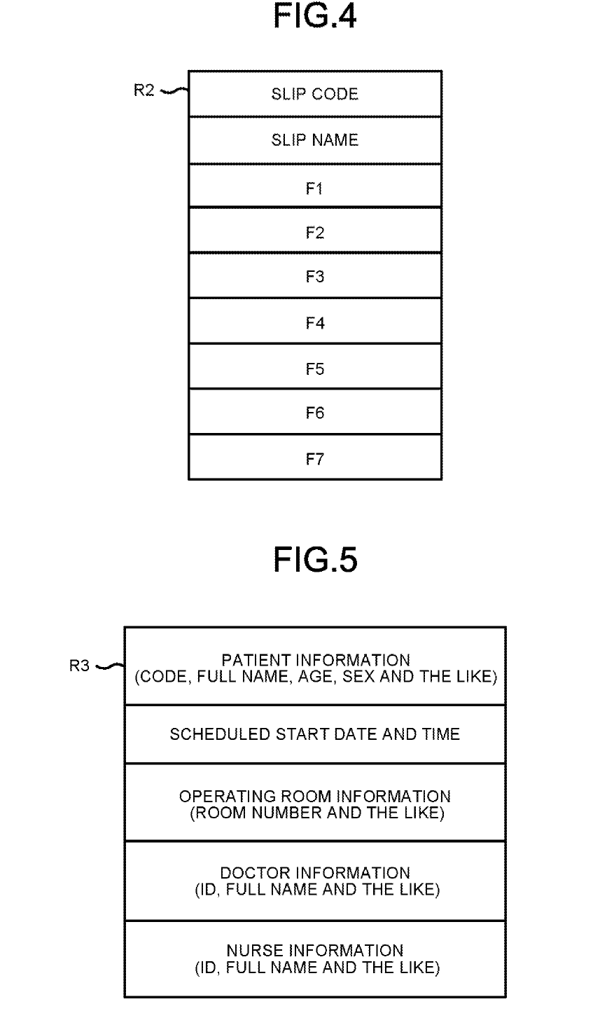

The slip database 442 stores a slip record R2 generated for each type of slips which can be issued by the medicament management apparatus 1. As shown in FIG. 4, the slip record R2 contains data items such as slip code, slip name and first˜seventh flags F1˜F7. A latest version of the slip database 442 is created by a computer system different from the medicament management apparatus and is downloaded to the auxiliary storage device 44 through the memory card 60.

The slip code is a unique code for specifying the type of the slip. The slip name is a unique name printed on the slip. The first flag F1 identifies whether or not the slip is output. In the present embodiment, “1” indicates that the slip is output and “0” indicates that the slip is not output. The second flag F2 identifies whether or not the drug code is printed on the slip. In the present embodiment, “1” indicates that the drug code is printed and “0” indicates that the drug code is not printed. The third flag F3 identifies whether or not the drug price code is printed on the slip. In the present embodiment, “1” indicates that the drug price code is printed and “0” indicates that the drug price code is not printed. The fourth flag F4 identifies whether or not the computing code is printed on the slip. In the present embodiment, “1” indicates that the computing code is printed and “0” indicates that the computing code is not printed. The fifth flag F5 identifies whether or not the drug name is printed on the slip. In the present embodiment, “1” indicates that the drug name is printed and “0” indicates that the drug name is not printed. The sixth flag F6 identifies whether or not the sales name is printed on the slip. In the present embodiment, “1” indicates that the sales name is printed and “0” indicates that the sales name is not printed. The seventh flag F7 identifies whether or not the computer processing name is printed on the slip. In the present embodiment, “1” indicates that the computer processing name is printed and “0” indicates that the computer processing name is not printed.

The slip database 442 functions as a slip information storage section that stores, for each use of the slip which is used to notify information of the medicament used or consumed at the medical site, type of the drug codes required for each use, a plurality of types of names assigned to each medicament respectively, and information for identifying whether or not the slip is made.

Returning to FIG. 2, following description is given.

The clock section 45 keeps the current date and time.

The touch panel controller 46 controls the touch panel 11. The touch panel 11 is formed by arranging a touch sensor 11t serving as an input section on the display part of a display 11d serving as a display section. The touch panel controller 46 controls the screen display of the display 11d and monitors the signal of the touch sensor 11t. Then the touch panel controller 46 detects input data according to the coordinate information of the touched position on the display 11d and the screen information of the display 11d at that time.

The card reader controller 47 acquires the card data read by the card reader 12 and writes the card data in a given area (hereinafter referred to as a card data area) of the RAM 43.

The scanner interface 48 electrically connected with the scanner 20 performs transmission/reception of data signals to and from the scanner 20 to acquire the code data scanned by the scanner 20.

The printer interface 49 electrically connected with the printer 30 performs transmission/reception of data signals to and from the printer 30 and drives the printer 30 to print the used medicament slip and the like.

The memory card interface 50 reads the data stored in the memory card 60 mounted in a detachable manner and writes data in the memory card.

The medicament management apparatus 1 with such a constitution is arranged in an operating room. For example, before the first surgery in one day is started, the memory card 60 in which a surgery database 601 is stored is mounted in the memory card interface 50. The data record (hereinafter referred to as a surgery record R3) relating to the surgeries scheduled in the operating room on that day is stored in the surgery database 601.

As shown in FIG. 5, the surgery record R3 contains patient information, scheduled start date and time, operating room information, doctor information, nurse information and the like. The patient information contains the patient code, full name, age, sex and the like of a patient who receives the surgery. The scheduled start date and time is the date and time when the scheduled surgery is started. The operating room information contains a room number for specifying the operating room and the like. The doctor information contains the ID, full name and the like of each doctor in charge of the surgery. The nurse information contains the ID, full name and the like of each nurse who assists the surgery.

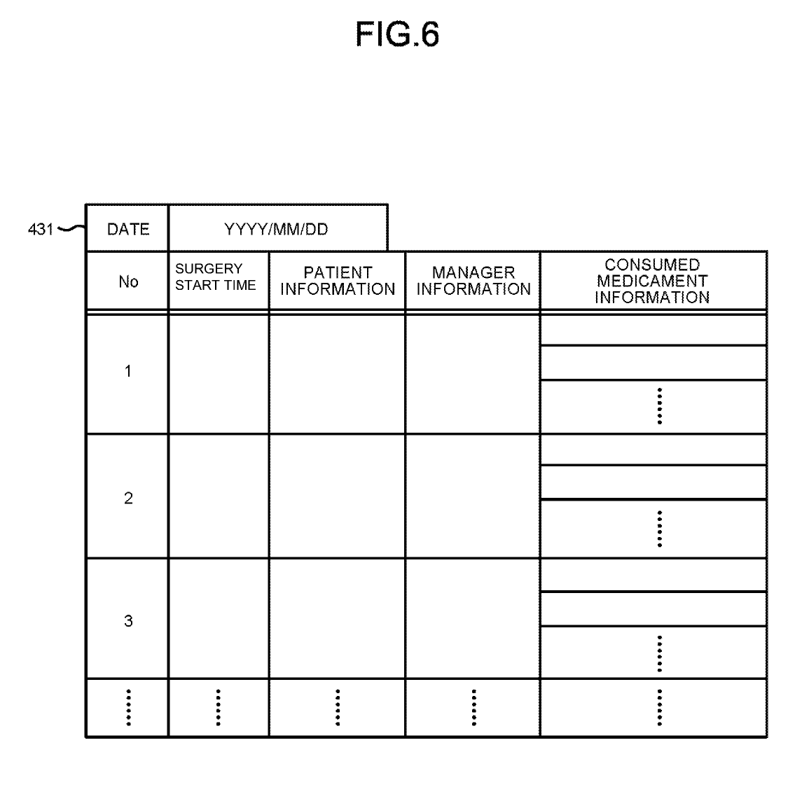

If the memory card 60 in which the surgery database 601 is stored is mounted in the memory card interface 50, a medicament registration table 431 consisting of multiple areas shown in FIG. 6 is formed in the RAM 43 of the main body 10. The medicament registration table 431 includes a date area. The medicament registration table 431 also includes areas for respectively storing the surgery time, patient information, manager information and consumed medicament information in association with row numbers starting from “1”. Further, the current date kept by the clock section 45 is set in the date area.

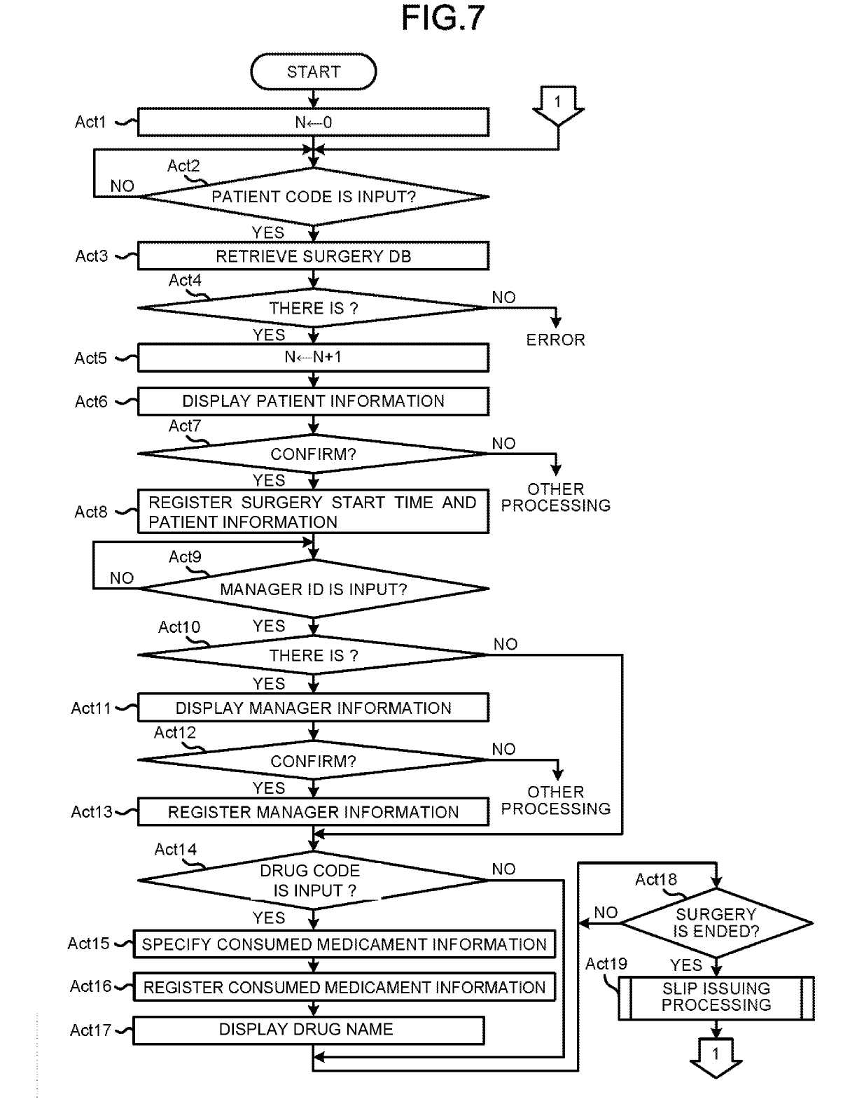

Then, the CPU 41 starts the information processing according to the procedure shown in the flowchart in FIG. 7. The processing is carried out according to the medicament management program stored in the ROM 42 in advance. The CPU 41 resets the number counter N to “0” (ACT 1). The number counter N is formed in the RAM 43, for example.

The CPU 41 waits for until the patient code is input (ACT 2). A staff who is appointed as a manager of drug (hereinafter referred to as a medicament manager) among the surgery staffs (the doctor or nurse) first slides the patient card of the patient who receives the surgery along the slide groove 12A to read the card data containing the patient code. Alternatively, the medicament manager operates the touch panel 11 to input the patient code recorded in a medical record and the like of the patient.

If the patient code is input through the card reader 12 or the touch panel 11 (YES in ACT 2), the CPU 41 retrieves the surgery database 601 (ACT 3), and determines whether or not there is the surgery record R3 containing the patient code as the patient information in the surgery database 601 (ACT 4). If the surgery record R3 is not in the surgery database 601 (NO in ACT 4), the CPU 41 displays a message of error of the patient code on the touch panel 11.

On the contrary, if the surgery record R3 is in the surgery database 601 (YES in ACT 4), the CPU 41 reads the surgery record R3 from the surgery database 601 and writes the surgery record R3 in the given area (hereinafter referred to as a surgery data area) of the RAM 43. Further, the CPU 41 increases the number counter N by “1” (ACT 5).

The CPU 41 detects the patient information (patient code, full name, age, sex and the like) from the surgery record R3 in the surgery data area, and displays the information on the touch panel 11 (ACT 6). Then the CPU 41 waits for until a confirmation operation is carried out (ACT 7). An image of a confirmation button as well as the patient information is displayed on the touch panel 11, and the CPU 41 waits for until the confirmation button is touched. The medicament manager confirms the displayed patient information and touches the confirmation button if the patient information displayed is entirely consistent with the patient who receives the surgery.

If a touch input of the confirmation button is detected by the touch panel controller 46 (YES in ACT 7), the CPU 41 sets the surgery start time and the patient information in an area with a number consistent with the content of the number counter N (hereinafter referred to as a number N area) in the medicament registration table 431 (ACT 8). The surgery start time is the current time kept by the clock section 45. The patient information is contained in the surgery record R3 in the surgery data area.

The CPU 41 waits for until the ID of the medicament manager is input (ACT 9). The medicament manager slides his or her own ID card along the slide groove 12A to read the card data containing the ID thereof. Alternatively, the medicament manager operates the touch panel 11 to input his or her own ID.

If the ID of the surgery staff is input through the card reader 12 or the touch panel 11 (YES in ACT 9), the CPU 41 retrieves the doctor information or the nurse information containing the ID thereof from the surgery record R3 stored in the surgery data area (ACT 10). As a result, if the doctor information or the nurse information exists in the surgery record R3 (YES in ACT 10), the CPU 41 displays the full name contained in the doctor information or the nurse information on the touch panel 11 (ACT 11). Then the CPU 41 waits for until the confirmation operation is carried out (ACT 12). An image of a confirmation button as well as the full name of the doctor or the nurse is displayed on the touch panel 11, and the CPU 41 waits for until the confirmation button is touched. The medicament manager confirms the displayed full name and touches the confirmation button if the full name displayed is consistent with the doctor or the nurse who is in charge of or assists the surgery.

If a touch input of the confirmation button is detected by the touch panel controller 46 (YES in ACT 12), the CPU 41 sets the manager information in the area specified with the number N in the medicament registration table 431 (ACT 13). The manager information is the doctor information or the nurse information detected from the surgery record R3 in the processing in ACT 10. Sequentially, the CPU 41 executes the processing in ACT 14.

If the doctor information or the nurse information does not exist in the surgery record R3 in the processing in ACT 10 (NO in ACT 10), the CPU 41 executes the processing in ACT 14 without carrying out the processing in ACT 11-ACT 13 described above.

In ACT 14, the CPU 41 confirms whether or not the drug code is input. If the drug code is not input (NO in ACT 14), the CPU 41 confirms whether or not the termination of the surgery is declared (ACT 18). An image of a termination button is displayed on the touch panel 11, and thus if the termination button is touched, the CPU 41 recognizes that the surgery is ended. If the termination of the surgery is not declared (NO in ACT 18), the CPU 41 reconfirms whether or not the drug code is input (ACT 14).

Every time medicament is used or consumed in the surgery, the medicament manager holds the container in which the medicament is stored to the scanner 20 such that the surface of the container on which the data code symbol is attached faces to the scanner 20. In this way, the data code symbol is scanned by the scanner 20 and the data code is acquired by the main body 10 through the scanner interface 48. The CPU 41 analyzes whether or not the data code is the drug code. If the data code is the drug code (YES in ACT 14), the CPU 41 retrieves the medicament database 441 with the drug code to detect the medicament record R1 containing the drug code (ACT 15: specifying module). Then, the CPU 41 sets the information of each item contained in the medicament record R1 in the area specified with the number N in the medicament registration table 431 as the consumed medicament information (ACT 16: registration module). Further, the CPU 41 extracts the drug name among information of each item contained in the medicament record R1 and displays the drug name on the touch panel 11 (ACT 17: display module).

The CPU 41 executes each processing in ACTs 15, 16 and 17 every time the drug code is read by the scanner 20. Thus, the data of the medicament record R1 for each medicament used in the surgery is cumulatively stored in the registration order in the consumed medicament information area corresponding to the number N of the medicament registration table 431.

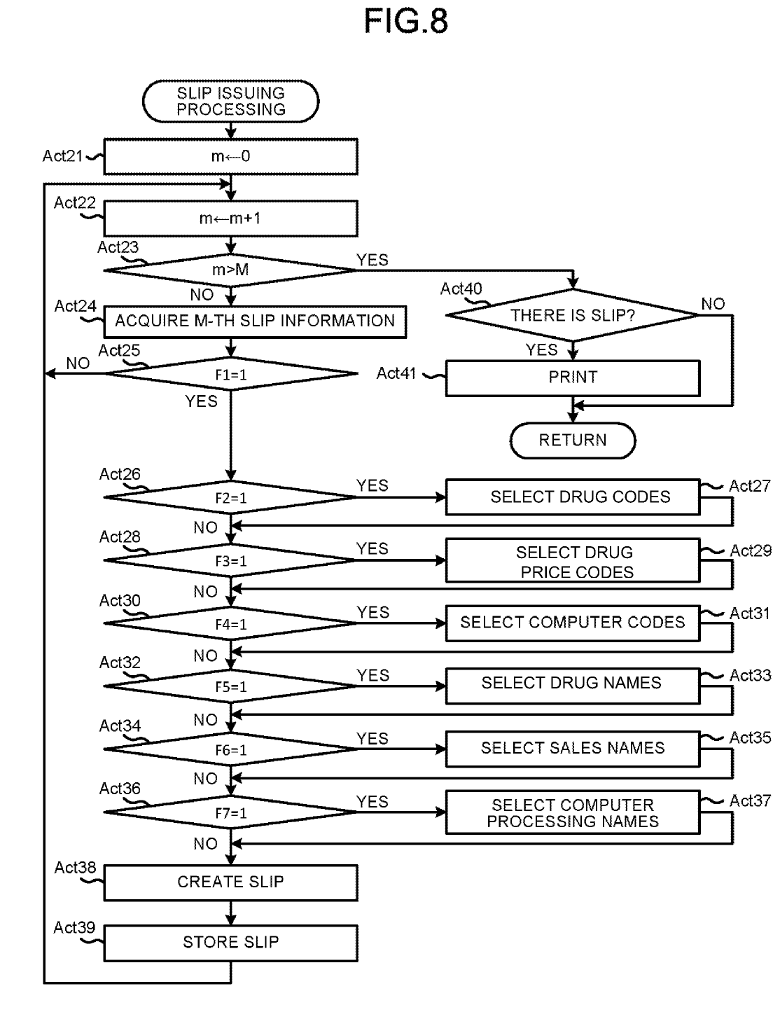

If touch panel controller 46 detects that the termination button is touched (YES in ACT 18), the CPU 41 executes the slip issuing processing according to the procedure specifically shown in the flowchart in FIG. 8 (ACT 19). After the slip issuing processing is ended, the CPU 41 executes the processing in ACT 2 to wait for until the patient code of a next patient is input.

As shown in FIG. 8, when entering the slip issuing processing, the CPU 41 resets a record counter m to “0” (ACT 21). The record counter m is formed in the RAM 43, for example.

The CPU 41 increases the record counter m by “1” (ACT 22). Then the CPU 41 confirms whether or not the record counter m is greater than the maximum number M of the slip record R2 stored in the slip database 442 (ACT 23).

If the record counter m is not greater than the maximum number M of the slip record R2 (NO in ACT 23), the CPU 41 reads the m-th (m is the value in the record counter m) slip record R2 stored in the slip database 442 and writes it in a given area of the RAM 43 (hereinafter referred to as a slip data area) (ACT 24). Then the CPU 41 sequentially checks the first˜seventh flags F1-F7 of the slip record R2 written in the slip data area.

First, the CPU 41 checks the first flag F1 (ACT 25). If the first flag F1 is “0” (NO in ACT 25), the slip specified with the slip record R2 written in the slip data area is not an output target. In this case, the CPU 41 executes the processing in ACT 22 to further increase the record counter m by “1”.

On the contrary, if the first flag F1 is “1” (YES in ACT 25), the slip specified with the slip record R2 is an output target. In this case, the CPU 41 checks the second flag F2 (ACT 26). If the second flag F2 is “1” (YES in ACT 26), the CPU 41 respectively selects the drug codes from all the medicament records R1 registered in the consumed medicament information area corresponding to the number N in the medicament registration table 431 and adds the drug codes to the slip data area in the registration order (ACT 27).

In a case in which the drug codes are added to the slip data area, or the second flag F2 is “0” (NO in ACT 26), the CPU 41 checks the third flag F3 (ACT 28). If the third flag F3 is “1” (YES in ACT 28), the CPU 41 selects the drug price codes from the same medicament records R1 respectively, and adds the drug price codes to the slip data area in the registration order (ACT 29).

In a case in which the drug price codes are added to the slip data area, or the third flag F3 is “0” (NO in ACT 28), the CPU 41 checks the fourth flag F4 (ACT 30). If the fourth flag F4 is “1” (YES in ACT 30), the CPU 41 selects the computing codes from the same medicament records R1 respectively, and adds the computing codes to the slip data area in the registration order (ACT 31).

In a case in which the computing codes are added to the slip data area, or the fourth flag F4 is “0” (NO in ACT 30), the CPU 41 checks the fifth flag F5 (ACT 32). If the fifth flag F5 is “1” (YES in ACT 32), the CPU 41 selects the drug names from the same medicament records R1 respectively, and adds the drug names to the slip data area in the registration order (ACT 33).

In a case in which the drug names are added to the slip data area, or the fifth flag F5 is “0” (NO in ACT 32), the CPU 41 checks the sixth flag F6 (ACT 34). If the sixth flag F6 is “1” (YES in ACT 34), the CPU 41 selects the sales names from the same medicament records R1 respectively, and adds the sales names to the slip data area in the registration order (ACT 35).

In a case in which the sales names are added to the slip data area, or the sixth flag F6 is “0” (NO in ACT 34), the CPU 41 checks the seventh flag F7 (ACT 36). If the seventh flag F7 is “1” (YES in ACT 36), the CPU 41 selects the computer processing names from the same medicament records R1 respectively, and adds the computer processing names to the slip data area in the registration order (ACT 37).

In a case in which the computer processing names are added to the slip data area, or the seventh flag F7 is “0” (NO in ACT 36), the CPU 41 creates the printing data of the slip according to the surgery start time, the patient information and the manager information corresponding to the number N of the medicament registration table 431 and the data stored in the slip data area (ACT 38: creation module). Then the CPU 41 stores the created slip printing data in a print buffer of the RAM 43 (ACT 39). Sequentially, the CPU 41 executes the processing in ACT 22 to further increase the record counter m by “1”.

In this way, every time the record counter m is increased, the CPU 41 repeatedly executes the processing in ACT 23-ACT 39. Thus, the printing data of the slip specified with the slip record R2 as the output target is stored in the print buffer.

If the value in the record counter m is greater than the maximum number M of the slip record R2 (YES in ACT 23), the CPU 41 confirms whether or not the slip data is stored in the print buffer (ACT 40). If the slip data is stored in the print buffer (YES in ACT 40), the CPU 41 outputs the slip data to the slip printer 30 through the printer interface 49 (ACT 41: output module). In this way, the slip according to the slip data is printed by the slip printer 30 and issued from the slip issuing port 31.

If the slip data is not stored in the print buffer (NO in ACT 40), the CPU 41 does not execute the processing in ACT 41. Then, the slip issuing processing is ended.

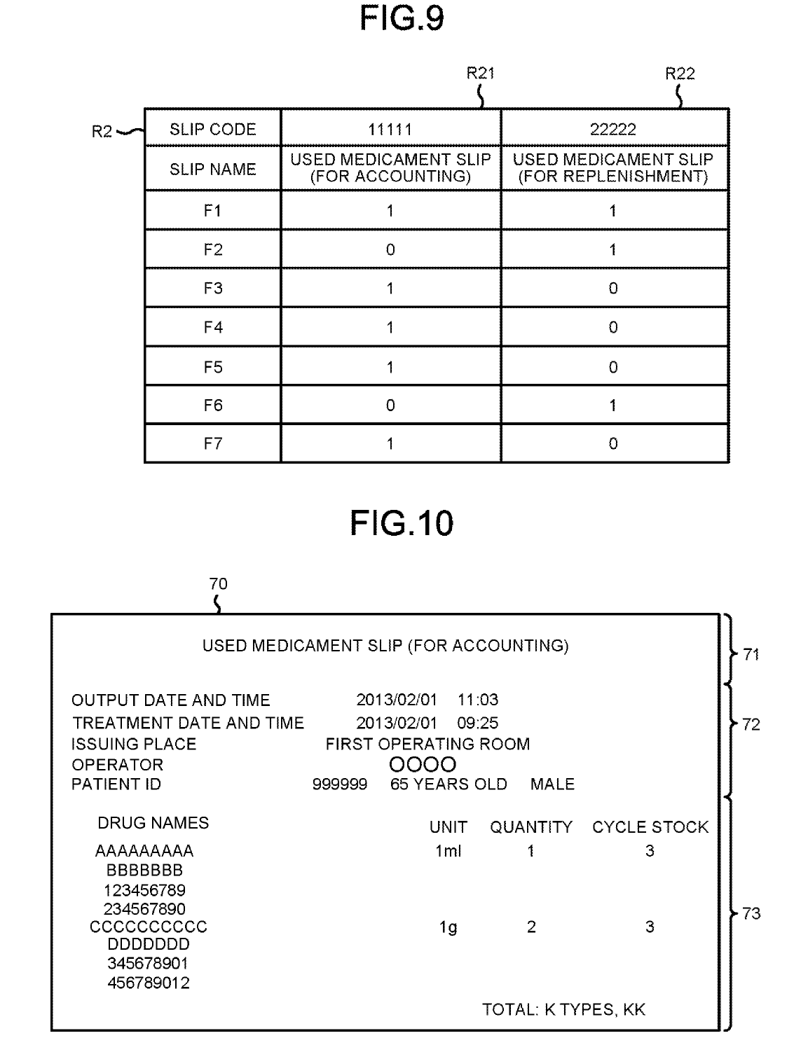

FIG. 9 is a diagram illustrating a specific example of the slip record R2. In FIG. 9, the slip record R21 is used for the used medicament slip for accounting which is to be submitted to the medical accounting department to charge the cost of the used medicament. A unique slip code “11111” and a slip name “Used Medicament Slip (for accounting)” are set in the slip record R21. Further, as to the first˜seventh flags F1-F7, the first flag F1, the third flag F3, the fourth flag F4, the fifth flag F5 and the seventh flag F7 come to “1”, while the second flag F2 and the sixth flag F6 come to “0”.

The used medicament slip for accounting is an output target because the first flag F1 is “1”. Further, since the third flag F3, the fourth flag F4, the fifth flag F5 and the seventh flag F7 are “1”, the drug price codes, the computing codes, the drug names and the computer processing names are respectively extracted from all the medicament records R1 registered in the consumed medicament information area of the medicament registration table 431 and printed on the used medicament slip for accounting.

FIG. 10 is a diagram illustrating an output example of the used medicament slip for accounting 70. The used medicament slip for accounting 70 is divided into a header area 71, a basic information area 72 and a detail information area 73. The slip name is printed in the header area 71. The output date and time, the treatment date and time, the issuing place, the operator, the patient ID and the like are printed in the basic information area 72. The drug name, the unit, the quantity and the cycle stock are printed in the detail information area 73. As to the drug name, the “drug name”, the “computer processing name”, the “drug price code” and the “computing code” are printed in order from the top.

In this way, as to the used medicament, the computing code used when the medical institution charges the insurance institution a medical fee and the drug price codes assigned to the drugs listed in the National Health Insurance Drug Price Standard designated by a public institution are printed on the used medicament slip for accounting 70, and thus, the information required to charge the cost for the used medicament can be obtained easily. Further, as to the name of the used medicament, in addition to the drug name serving as the official name, the computer processing name used when the medical institution charges the insurance institution a medical fee is also printed on the used medicament slip for accounting 70, and also, information required to charge the cost for the used medicament can be obtained easily.

In FIG. 9, the slip record R22 is used for the used medicament slip for replenishment which is to be submitted to the medicament management department to request a replenishment of the used medicament. A unique slip code “22222” and a slip name “Used Medicament Slip (for replenishment)” are set in the slip record R22. Further, as to the first˜seventh flags F1-F7, the first flag F1, the second flag F2 and the sixth flag F6 come to “1”, while the third flag F3, the fourth flag F4, the fifth flag F5 and the seventh flag F7 come to “0”.

The used medicament slip for replenishment is an output target because the first flag F1 is “1”. Further, since the second flag F3 and the sixth flag F6 are “1”, the drug codes and the sales names are respectively extracted from all the medicament records R1 registered in the consumed medicament information area of the medicament registration table 431 and printed on the used medicament slip for replenishment.

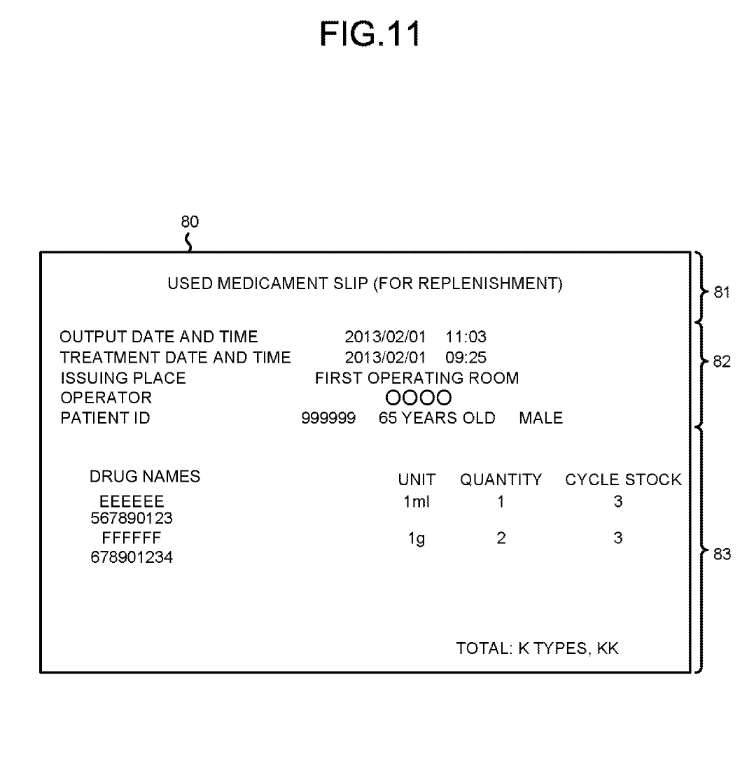

FIG. 11 is a diagram illustrating an output example of the used medicament slip for replenishment 80. The used medicament slip for replenishment 80 is divided into a header area 81, a basic information area 82 and a detail information area 83. The slip name is printed in the header area 81. The output date and time, the treatment date and time, the issuing place, the operator, the patient ID and the like are printed in the basic information area 82. The drug name, the unit, the quantity and the cycle stock are printed in the detail information area 83. As to the drug name, the “sales name” and the “drug code” are printed in order from the top.

In this way, as to the used medicament, the drug code consistent with the data code attached to the container in which the medicament is stored is printed on the used medicament slip for replenishment 80. Further, the sales name serving as a common name used when the medicament is sold as medical supplies is also printed on the used medicament slip for replenishment 80. Thus, the medicament that needs to be replenished from the medicament storage locker can be easily specified from the content of the used medicament slip for replenishment 80.

As stated above, in accordance with the present embodiment, it is possible to omit the work of counting the quantity of the medicament used in the surgery, which can greatly reduce the workload of the manager for medicament. Further, there will be no counting error or transcription error of the medicament used, which can prevent that charging the cost of the used medicament or the replenishment to the storage locker is left out by mistake.

The present invention is not limited to the embodiment described above.

For example, in the embodiment described above, the medicament management apparatus 1 includes the scanner 20 and the slip printer 30 separate from the main body 10. However, the scanner 20 and the slip printer 30 is not necessarily required. For example, in a case in which an RFID (Radio Frequency Identification) tag for storing the drug code is attached to the container in which the medicament is stored, an RFID tag reader can be used instead of the scanner 20. Further, the slip is not printed but may be output as an electronic data to display on a display device. In this case, a monitor device may be used for the slip printer 30. Moreover, a communication interface such as a LAN (Local Area Network) interface may be arranged in the main body 10, and the slip may be output and displayed on the screen of a computer which is connected to the outside through a network. Alternatively, the slip is output to and printed by a network printer.

Further, although the drug name is displayed in the processing in ACT 17 in the embodiment described above, the displayed name is not limited to the drug name. For example, the sales name or the computer processing name may also be displayed. Alternatively, the data for designating a name to be displayed may be added to the medicament record R1, thereby displaying a name different from one another for each medicament.

In addition, the transfer of the medicament management apparatus 1 is generally carried out in a state where the programs such as the medicament management program are stored in the ROM 42. However, the preset invention is not limited to this. The medicament management program and the like transferred separately from a computer device may be written in a writable storage device of the computer device through an operation of a user and the like. The transfer of the medicament management program and the like may be carried out by recording the program in a removable recording medium, or through a communication via a network. The form of the recording medium is not limited as long as the recording medium can store programs like a CD-ROM, a memory card and the like, and is readable by an apparatus. Further, the function realized by an installed or downloaded program can also be realized through the cooperation with an OS (Operating System) installed in the apparatus and the like.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A medicament management apparatus, comprising:
a medicament information storage section configured to store a plurality of types of drug codes which are respectively assigned to each medicament;
a slip information storage section configured to store, for each different use of a slip for notifying information of the medicament used at a medical site, information of the type of drug codes required for the use of the slip;
a specifying module configured to specify the medicament used at the medical site;
a registration module configured to register information relating to the medicament specified by the specifying module;
a creation module configured to acquire the drug code of the medicament registered by the registration module for each slip having different use from the medicament information storage section to create slips for uses different from one another based on the information stored in the slip data storage section; and
an output module configured to output the slips for uses different from one another created by the creation module.

2. The medicament management apparatus according to claim 1, wherein
the medicament information storage section further stores a plurality of types of names which are respectively assigned to each medicament;
the slip information storage section further stores, for each use of the slip, the type of the names required for the use of the slip; and
the creation module acquires the drug code and the name of the medicament registered by the registration module for each slip having different use from the medicament information storage section to create slips for different uses based on the information stored in the slip information storage section.

3. The medicament management apparatus according to claim 1, wherein
the slip information storage section further stores output information for identifying whether or not the slip is output for each slip having different use; and
the creation module creates a slip which is identified with the output information stored in the slip information storage section to be output.

4. The medicament management apparatus according to claim 2, further comprising:
a display module configured to extract the name of the drug specified by the specifying module from a plurality of types of names stored in the medicament information storage section and display the extracted drug name on a display section.

5. The medicament management apparatus according to claim 1, wherein
the specifying module specifies the medicament according to the data code attached to a container in which the medicament is stored.

6. A method for managing a medicament by a medicament managing apparatus having a medicament information storage section which stores a plurality of types of drug codes respectively assigned to each medicament, and a slip information storage section which stores, for each different use of a slip for notifying information of a consumed medicament at a medical site, information of the types of drug codes required for the use of the slip, including:
specifying a medicament which is used at the medical site;
registering information relating to the specified medicament;
acquiring a drug code of the registered medicament for each slip having different use from the medicament information storage section based on the information stored in the slip information storage section;
creating slips for different uses using the acquired drug code; and
outputting the slips created for different uses.
